(19) United States
(12) Patent Application Publication
(10) Pub. No.: US 2026/0351877 A1
(43) Pub. Date: Nov. 5, 2026

(54) BOARD-END CONNECTOR

(71) Applicant: BIZLINK INTERNATIONAL CORP., New Taipei City (TW)

(72) Inventors: Wei-Hsiang KAO, New Taipei City (TW); Chin-An HSIEH, New Taipei City (TW)

(21) Appl. No.: 19/634,116

(22) Filed: Mar. 31, 2026

(30) Foreign Application Priority Data
Apr. 30, 2025 (TW) 114116422

(51) Int. Cl. H01R 12/72; H01R 12/70; H01R 12/71; H01R 12/73; H01R 13/50; H01R 13/627

(52) U.S. Cl. CPC H01R 12/721; H01R 12/7082; H01R 12/712; H01R 12/737; H01R 13/50; H01R 13/6273

(57) ABSTRACT

A board-end connector includes a housing, two terminal sets, and two rotating boards. The housing includes an inner cavity with two corresponding inner wall surfaces. The two terminal sets include grounding terminals and signal terminals. The two rotating boards are rotatably connected to the housing and are respectively adjacent to the corresponding inner wall surfaces. The two terminal sets are respectively in contact with the two rotating boards, in which the two rotating boards are configured to be actuated to drive the two terminal sets to elastically deform, thereby causing the two terminal sets to respectively move toward the two inner wall surfaces.

### CROSS REFERENCE TO RELATED APPLICATION

This application claims priority to Taiwan Application Serial Number 114116422, filed Apr. 30, 2025, which is herein incorporated by reference in its entirety.

### BACKGROUND

### Field of Invention

The present disclosure relates to a connector, and particularly to a board-end connector.

### Description of Related Art

Connectors, as critical components for electrical signal transmission in electronic devices, are widely used in fields such as servers, data centers, communication equipment, and high-performance computing. However, faced with increasingly higher data transmission rates, existing connector structures have shown deficiencies in signal integrity and connection reliability. In particular, the stubs formed at the ends of traditional terminals are prone to causing signal reflection, crosstalk, and distortion in high-frequency environments, which severely affects system performance.

To mitigate these effects, some designs tend to shorten the terminal stubs to suppress signal degradation. However, if the terminals are too short, they are susceptible to bending, shifting, and resulting damage due to uneven stress in the absence of sufficient mating guidance during the insertion process of the connector. Therefore, how to provide a next-generation connector design suitable for high-speed transmission applications that balances signal integrity and terminal mechanical strength has become an important issue urgently needing to be overcome in this technical field.

### SUMMARY

To solve the aforementioned problems, the present disclosure provides a board-end connector including a housing, two terminal sets, and two rotating boards. The housing includes an inner cavity, which has two corresponding inner wall surfaces. The two terminal sets include grounding terminals and signal terminals. The two terminal sets are accommodated within the housing and are respectively adjacent to the corresponding inner wall surfaces. The two rotating boards are rotatably connected to the housing and are respectively adjacent to the corresponding inner wall surfaces. The two terminal sets are respectively in contact with the two rotating boards, in which the two rotating boards are configured to be actuated to drive the two terminal sets to elastically deform, thereby causing the two terminal sets to respectively move toward the two inner wall surfaces.

Another aspect of the present disclosure relates to a board-end connector including a housing, a terminal set, and a rotating board. The housing has an inner cavity, and the inner cavity has an inner wall surface. The terminal set is accommodated within the housing and adjacent to the inner wall surface. The rotating board is rotatably connected to the housing and in contact with the terminal set, and the rotating board comprises a pivot shaft and a distal end. The distal end is configured to move around the pivot shaft to be selectively spaced apart from the inner wall surface by a first distance or a second distance smaller than the first distance. The rotating board is configured to rotate and drive the terminal set to elastically deform toward the inner wall surface, such that a spacing between the distal end and the inner wall surface changes from the first distance to the second distance.

In summary, due to the ingenious design of the rotating boards and the terminal sets, the board-end connector can accommodate electronic component carriers of different thicknesses. This means that the board-end connector of the present disclosure can be applied to various device specifications without the need to design dedicated connectors for each thickness, thereby reducing design and manufacturing costs. In addition, the terminal sets can automatically adjust their positions, simplifying the installation process. Such a configuration reduces operational difficulty and the time required, thus improving maintenance efficiency. With the aforementioned advantages, the board-end connector of the present disclosure has broad application potential in fields requiring high-speed and stable transmission (such as artificial intelligence servers). Its high adaptability, reliability, and ease of use make it an ideal choice compatible with multiple component sizes.

### BRIEF DESCRIPTION OF THE DRAWINGS

The invention can be more fully understood by reading the following detailed description of the embodiments, with reference made to the accompanying drawings as follows:

FIG. 1 is a schematic perspective view of a board-end connector and an electronic component carrier in accordance with some embodiments of the present disclosure.

FIG. 2 is a schematic side view of a board-end connector and an electronic component carrier in accordance with some embodiments of the present disclosure.

FIG. 3 is a schematic side view of the electronic component carrier in FIG. 2 inserted into the board-end connector.

FIG. 4 is a schematic perspective view of a board-end connector in accordance with some embodiments of the present disclosure.

FIG. 5 is a schematic perspective view of a board-end connector in accordance with other embodiments of the present disclosure.

FIG. 6 is a schematic perspective view of a board-end connector from another viewing angle in accordance with some embodiments of the present disclosure.

FIG. 7 is a schematic side view of the board-end connector in FIG. 6.

FIG. 8 is a schematic perspective view of the board-end connector in FIG. 6 in another state.

FIG. 9 is a schematic side view of the board-end connector in FIG. 8.

### DETAILED DESCRIPTION

The following carefully discusses the embodiments of the present disclosure. However, it can be understood that the embodiments provide many applicable concepts, which can be implemented in a wide variety of specific contexts. The discussed and disclosed embodiments are for illustration only and are not intended to limit the scope of the present disclosure.

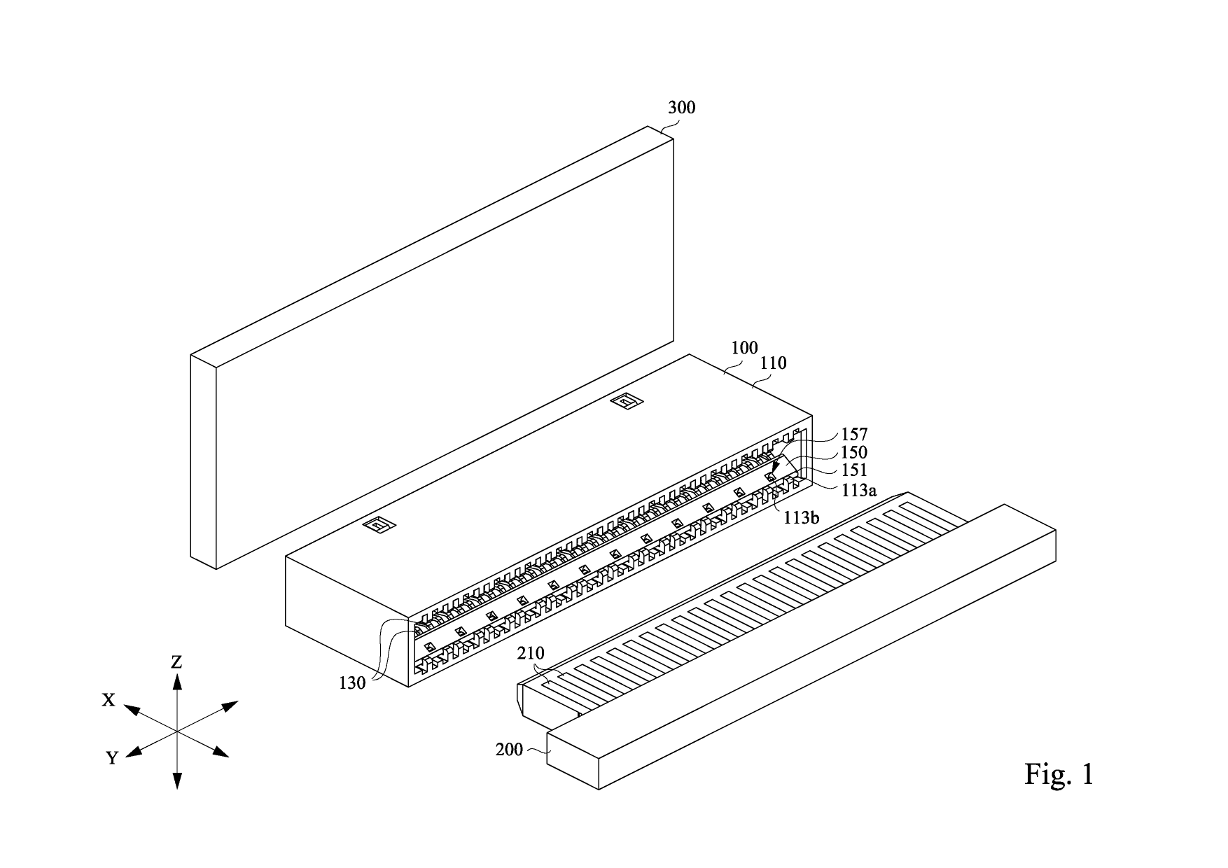

Please refer to FIGS. 1-3 simultaneously. FIGS. 1-3 illustrate a board-end connector 100 of the present disclosure, which can be used as a high-speed connector and applied in the field of artificial intelligence servers.

In some embodiments of the present disclosure, the board-end connector 100 is mainly composed of key components such as a housing 110, two terminal sets 130, a base 140, and two rotating boards 150. The board-end connector 100 is configured to receive an electronic component carrier 200 inserted therein and used therewith.

The housing 110 is an outer shell structure. The housing 110 can be made of metal, plastic, or other materials, and is used to accommodate and protect internal components or devices. In addition, the housing 110 includes an inner cavity 111, in which the inner cavity 111 includes an internal space or cavity of the housing 110 and is used to accommodate a component (for example, the electronic component carrier 200) inserted into the housing 110. The shape of the inner cavity 111 can be determined according to design requirements. The inner cavity 111 can be rectangular, circular, or other shapes with line-symmetric or centrally-symmetric characteristics. In addition, the inner cavity 111 includes two corresponding inner wall surfaces 111a. The two inner wall surfaces 111a can be corresponding boundaries or opposite boundaries of the inner cavity 111.

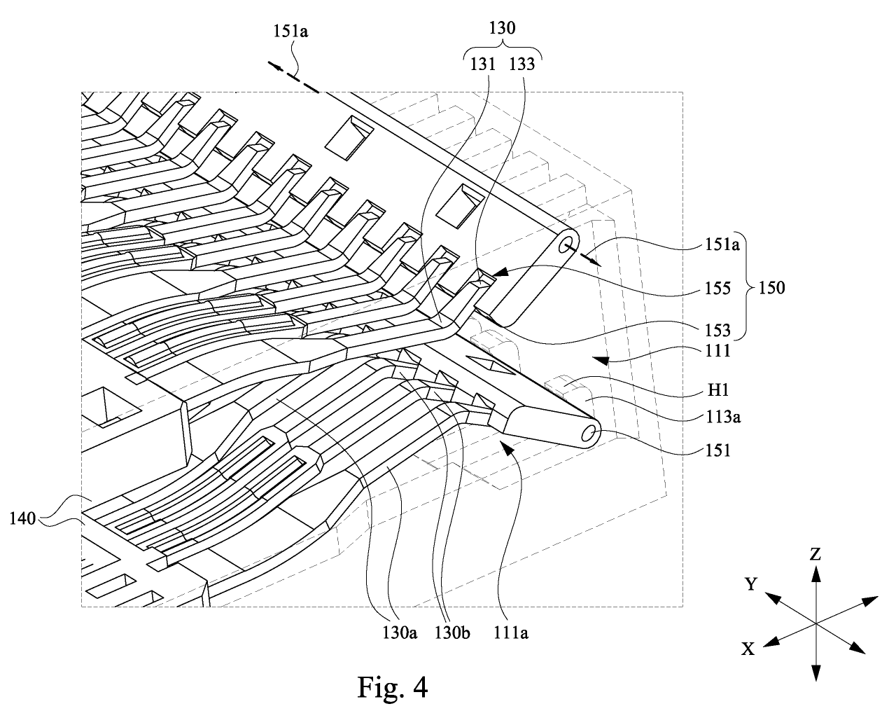

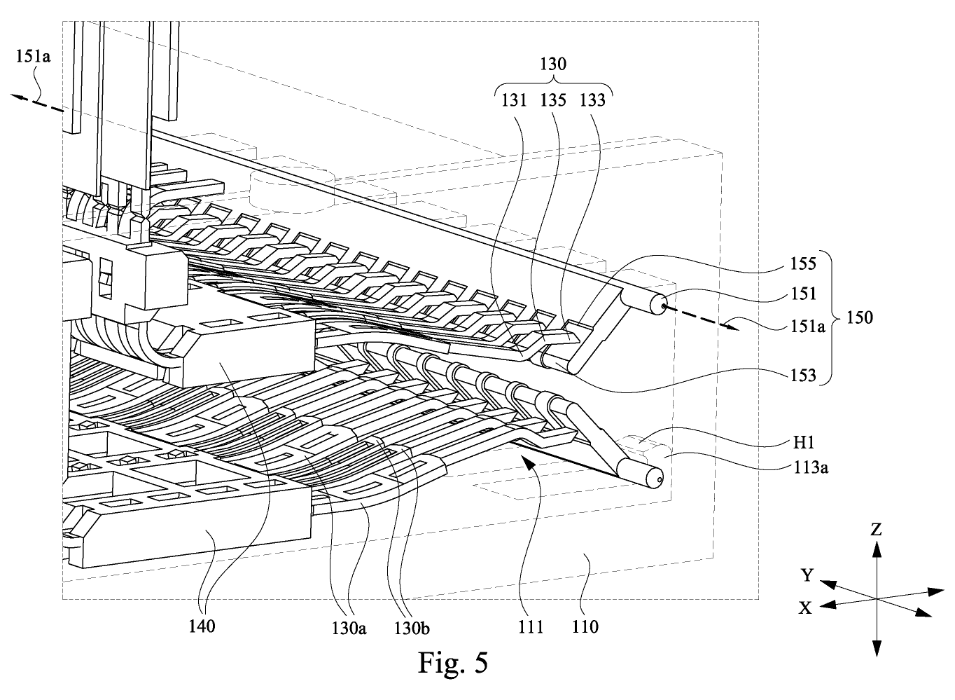

The terminal sets 130 are mainly consists of a plurality of grounding terminals 130a and signal terminals 130b arranged along an axial direction Y (please refer to FIGS. 4 and 5 simultaneously). The main function of the grounding terminals 130a is to provide a reference potential of a circuit and a stable ground connection to reduce electromagnetic interference and improve system stability. The signal terminals 130b are used for efficiently transmitting electrical signals, ensuring the accuracy and reliability of the signals. In addition, the grounding terminals 130a and the signal terminals 130b of the terminal sets 130 are made of elastic alloys (such as beryllium copper), so that the terminal sets 130 can return to their original shapes after being elastically deformed by pressure and then released.

The base 140 is made of an insulating material, and the base 140 is fixed to and connected within the housing 110. The terminal sets 130, such as the grounding terminals 130a and the signal terminals 130b, are fixed on the base 140, and the base 140 can carry and protect the terminal sets 130 accommodated on the base 140.

The rotating board 150 is a rotatable object relative to the housing 110, and the rotating board 150 is a flat plate-like structure.

The electronic component carrier 200 may be a circuit board, such as a double-sided printed circuit board, a multi-layer circuit board, a rigid circuit board, or a flexible circuit board.

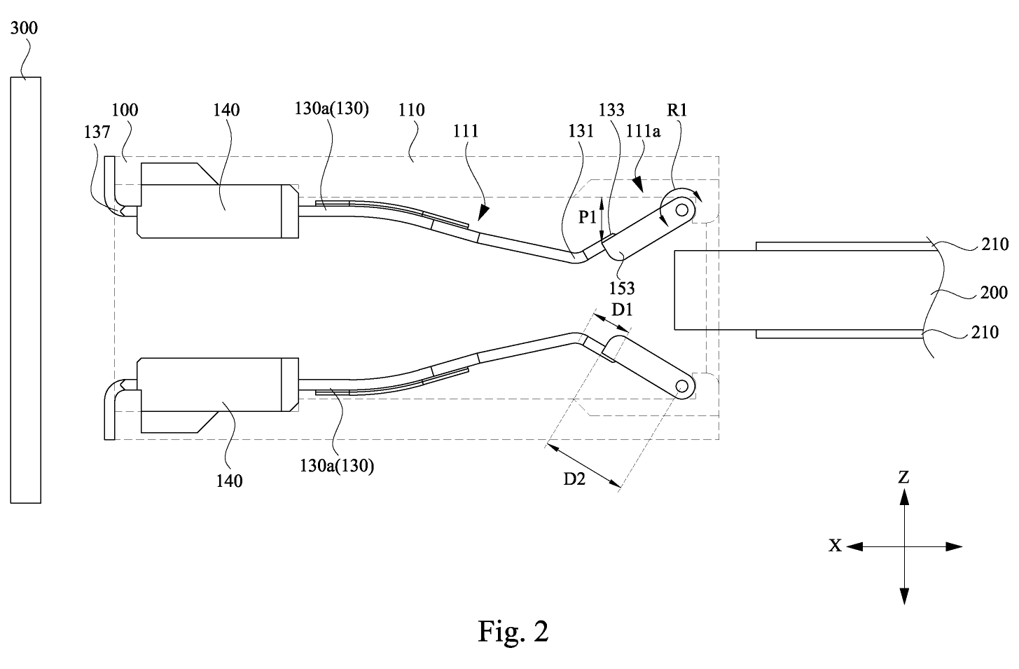

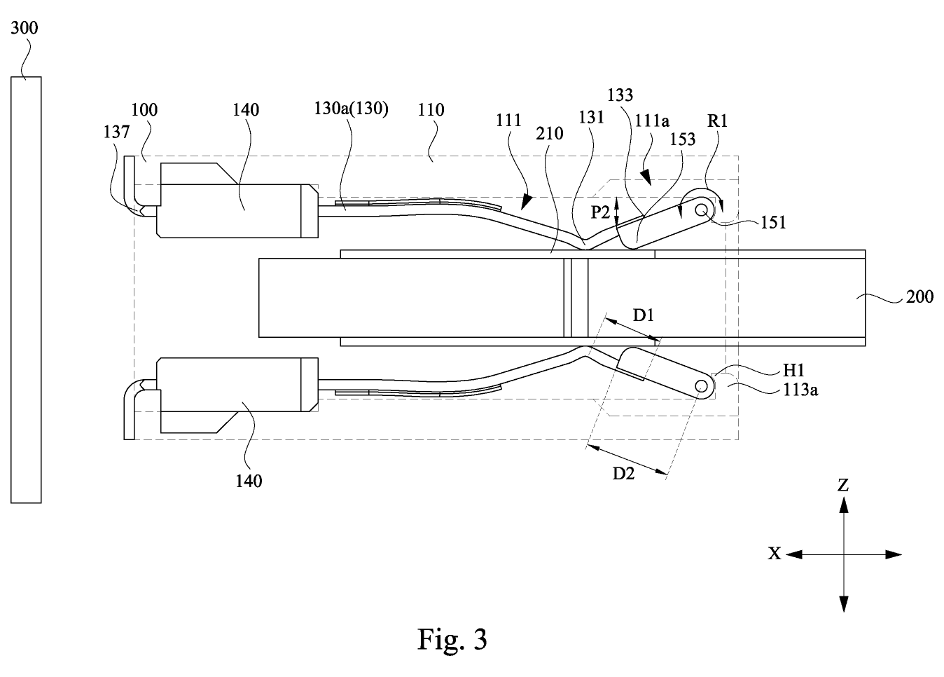

Specifically, the two terminal sets 130 are accommodated and fixed within the housing 110, in which the two terminal sets 130 are respectively adjacent to the corresponding two inner wall surfaces 111a. The two rotating boards 150 are accommodated within the housing 110, and the two rotating boards 150 are rotatably connected to the housing 110 and respectively adjacent to the corresponding two inner wall surfaces 111a of the housing 110. In addition, the two terminal sets 130 are respectively in contact or in connection with the two rotating boards 150, in which the two rotating boards 150 are configured to be pushed to drive the two terminal sets 130 to elastically deform and respectively move toward the two inner wall surfaces 111a. In practical applications, when a user inserts the electronic component carrier 200 into the inner cavity 111 of the housing 110, the electronic component carrier 200 pushes the two rotating boards 150, thereby causing the two terminal sets 130 to respectively elastically deform and move toward the two corresponding inner wall surfaces 111a. For example, the terminal sets 130 change from the state in FIG. 2 to the state in FIG. 3. Therefore, the two terminal sets 130 can clamp the electronic component carrier 200 from opposite sides of the electronic component carrier 200, and the grounding terminals 130a and the signal terminals 130b of the terminal sets 130 can be electrically connected to conductive lines 210 of the electronic component carrier 200. Because the two terminal sets 130 can elastically deform or move according to the thickness of the electronic component carrier 200, the board-end connector 100 can adapt to electronic component carriers 200 of different thicknesses, thereby providing compatibility with electronic component carriers 200 of different sizes and avoiding collisions between the terminal sets 130 and the electronic component carrier 200.

Furthermore, when the external force is removed (for example, when the electronic component carrier 200 is pulled out), the two terminal sets 130 automatically return to their original shapes by their elasticity. During this process, the two terminal sets 130 push the two rotating boards 150 and drive the two rotating boards 150 to move in a direction away from the inner wall surfaces 111a and return to their original positions. That is, the rotating board 150 returns from the state in FIG. 3 to the state in FIG. 2. Therefore, without applying additional external force to the two terminal sets 130, the terminal sets 130 can automatically drive the rotating boards 150 to return to the initial state after the electronic component carrier 200 is removed for preparing for the next operation.

Please refer to FIGS. 1-3 simultaneously. In some embodiments of the present disclosure, the terminal set 130 includes a bent portion 131, a front end portion 133, and a rear end portion 137, and the bent portion 131 is located between the front end portion 133 and the rear end portion 137.

The bent portion 131 is a portion of the terminal set 130 away from the corresponding inner wall surface 111a, in which the bent portion 131 is configured to electrically contact the component, such as the electronic component carrier 200, inserted into the housing 110. The front end portion 133 can be a free end of the grounding terminal 130a.

In addition, the rotating board 150 includes a pivot shaft 151 and a distal end 153. The pivot shaft 151 and the distal end 153 are respectively disposed at two ends of the rotating board 150, and the pivot shaft 151 is connected to the housing 110. When the rotating board 150 rotates along a rotational direction R1 via the pivot shaft 151, the distal end 153 also moves around the pivot shaft 151 along the rotational direction R1. Specifically, the distal end 153 is configured to move around the pivot shaft 151 to be selectively spaced apart from the corresponding inner wall surface 111a by a first distance P1 or a second distance P2 smaller than the first distance P1. The rotating board 150 is configured to rotate and drive the terminal set 130 to elastically deform toward the corresponding inner wall surface 111a, such that a spacing between the distal end 153 and the inner wall surface 111a changes from the first distance P1 to the second distance P2. The terminal set 130 is configured to provide an elastic restoring force to push the rotating board 150 when an external force is removed. The elastic restoring force drives the rotating board 150 to rotate away from the inner wall surface 111a, such that the spacing between the distal end 153 and the inner wall surface 111a changes from the second distance P2 back to the first distance P1.

Specifically, the front end portion 133 of the terminal set 130 is connected to or in contact with the distal end 153 of the rotating board 150. A distance D1 between the bent portion 131 and the front end portion 133 of the terminal set 130 is smaller than a distance D2 between an axis of the pivot shaft 151 of the rotating board 150 and the front end portion 133 of the terminal set 130. Through the combination of the terminal set 130 and the rotating board 150, the length of the terminal set 130 can be shortened, thereby reducing the overall size of the grounding terminals 130a and the signal terminals 130b, which improves signal transmission efficiency and can even provide the additional effect of avoiding signal reflection, crosstalk, and distortion.

Please refer to FIGS. 1-4 simultaneously. In some embodiments of the present disclosure, the rotating board 150 includes a groove 155. An opening of the groove 155 substantially faces the corresponding inner wall surface 111a and the bent portion 131 of the terminal set 130, in which the groove 155 extends to the distal end 153 of the rotating board 150.

Specifically, the front end portion 133 of the terminal set 130 is accommodated in the groove 155. An extending direction from the bent portion 131 to the front end portion 133 of the terminal set 130 generally extends toward the axis of the pivot shaft 151, and the terminal set 130 is disposed between the corresponding inner wall surface 111a and the rotating board 150. Therefore, when the rotating board 150 is pushed by the electronic component carrier 200 to rotate toward the corresponding inner wall surface 111a, the groove 155 moves around the pivot shaft 151 (along the rotational direction R1) and drives the terminal set 130 to elastically deform and move toward the corresponding inner wall surface 111a. In addition, the groove 155 is configured to be pushed by a thrust generated by the elastic recovery of the terminal set 130 to move relative to the pivot shaft 151. Specifically, the groove 155 moves around the pivot shaft 151 (along the rotational direction R1) in a direction away from the corresponding inner wall surface 111a.

Please refer to FIG. 5 simultaneously. In other embodiments of the present disclosure, the terminal set 130 further includes a hook portion 135, in which the hook portion 135 is defined between the bent portion 131 and the front end portion 133. Specifically, the front end portion 133 and the hook portion 135 of the terminal set 130 can be inserted into the groove 155, so that the terminal set 130 and the rotating board 150 can drive the terminal set 130 to move toward the corresponding inner wall surface 111a.

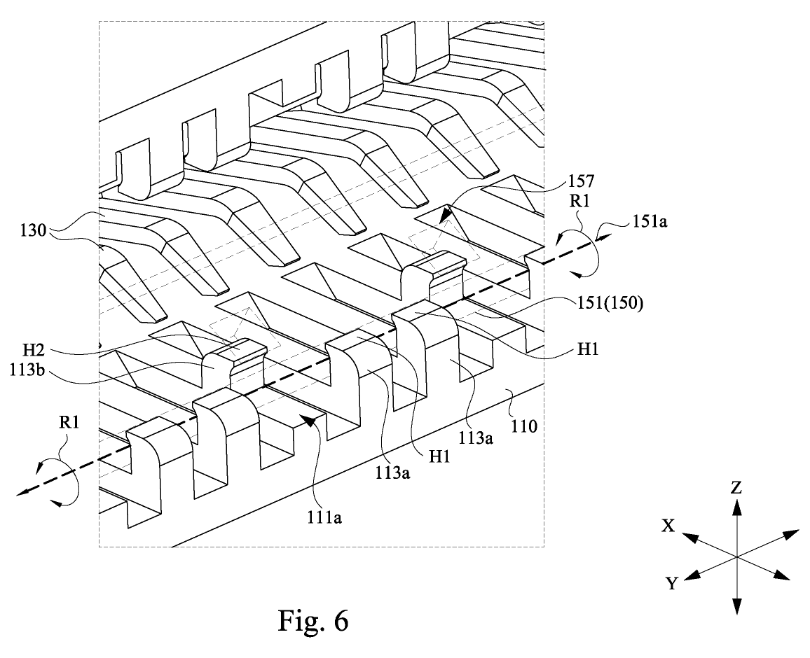

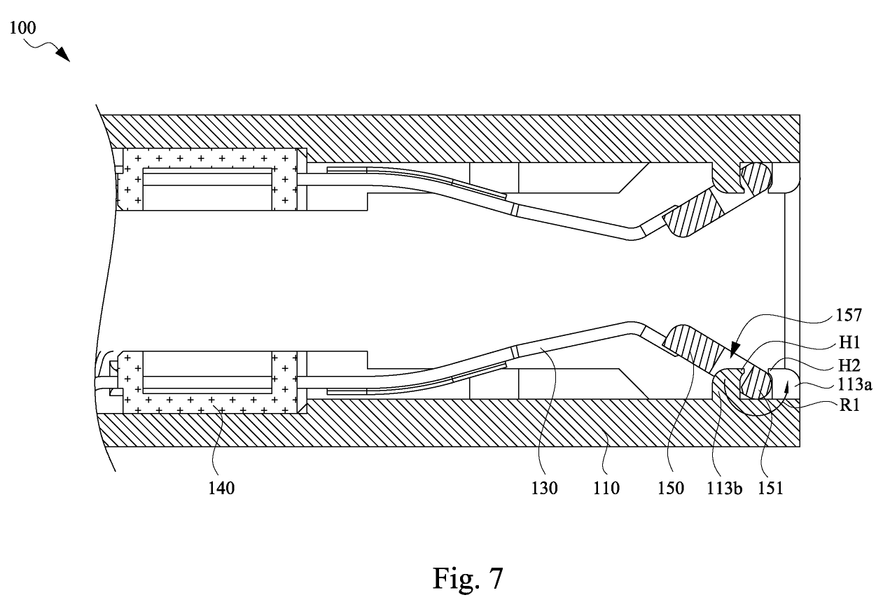

Please refer to FIGS. 6-9 simultaneously. The housing 110 includes a first fixing arm 113a and a second fixing arm 113b. The first fixing arm 113a and the second fixing arm 113b extend from the inner wall surface 111a, so the first fixing arm 113a and the second fixing arm 113b can be integrally formed with the housing 110. However, the first fixing arm 113a and the second fixing arm 113b can also be components fixed to the housing 110 by locking.

Specifically, the first fixing arm 113a and the second fixing arm 113b are separated and spaced apart in an axial direction X and are disposed on corresponding opposite two sides of the pivot shaft 151 in the axial direction X, so the first fixing arm 113a and the second fixing arm 113b simultaneously limit the pivot shaft 151 in the axial direction X. In addition, the first fixing arm 113a has a protrusion H1 extending toward the second fixing arm 113b along the axial direction X, and the second fixing arm 113b also has a protrusion H2 extending toward the first fixing arm 113a along the axial direction X. Therefore, the first fixing arm 113a and the second fixing arm 113b respectively extend from lateral sides of the pivot shaft 151 to a side of the pivot shaft 151 away from the corresponding inner wall surface 111a. The protrusion H1 and the protrusion H2 are located on the side of the pivot shaft 151 away from the corresponding inner wall surface 111a in the axial direction Y, so the protrusion H1, the protrusion H2, and the inner wall surface 111a simultaneously limit the pivot shaft 151 in the axial direction Y. In summary, the first fixing arm 113a and the second fixing arm 113b limit the pivot shaft 151 from at least three sides of the pivot shaft 151 through the protrusion H1 and the protrusion H2, and the pivot shaft 151 can stably rotate among the first fixing arm 113a, the second fixing arm 113b, and the inner wall surface 111a, thereby preventing the rotating board 150 from falling off the housing 110 due to rotation.

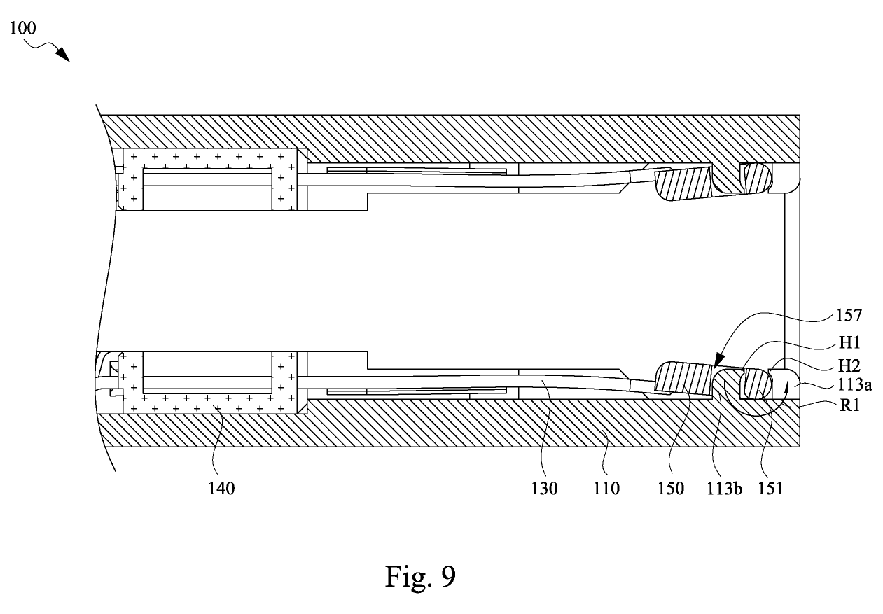

Please refer to FIGS. 6 and 9 simultaneously. In some embodiments of the present disclosure, the first fixing arm 113a and the second fixing arm 113b are provided in plural, in which the plurality of first fixing arms 113a and the plurality of second fixing arms 113b are arranged in a staggered manner with respect to a longitudinal axis 151a of the pivot shaft 151. In the present disclosure, the longitudinal axis 151a is an axis along the most primary extending direction of the pivot shaft 151. The longitudinal axis 151a can extend along the axial direction Y, and the longitudinal axis 151a and the axial direction Y are perpendicular to the rotational direction R1 of the pivot shaft 151.

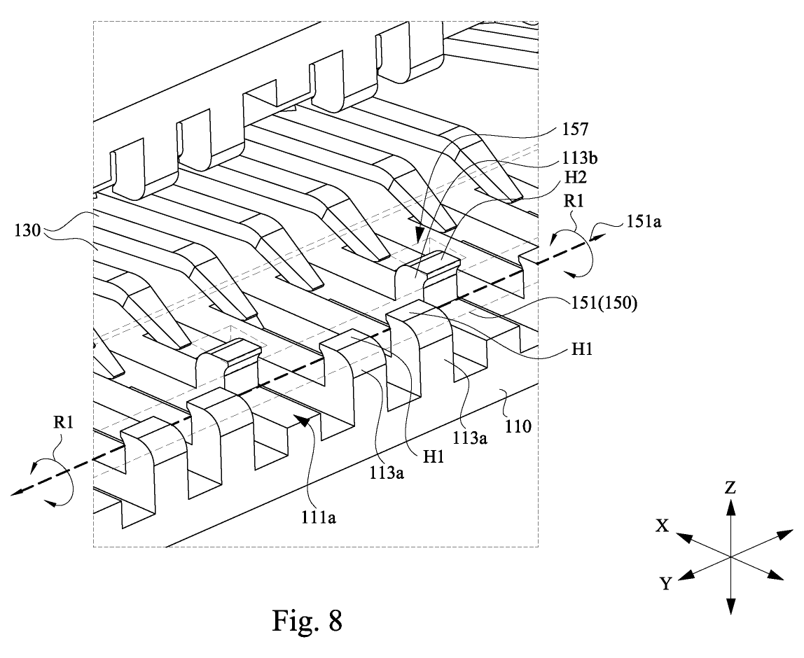

Specifically, the plurality of first fixing arms 113a and the plurality of second fixing arms 113b present a misaligned configuration in a direction perpendicular to the longitudinal axis 151a of the pivot shaft 151. In FIGS. 6 and 8, the plurality of first fixing arms 113a and the plurality of second fixing arms 113b present a misaligned configuration relative to the axial direction X. Therefore, the projection of the first fixing arm 113a toward the longitudinal axis 151a along the axial direction X and the projection of the second fixing arm 113b toward the longitudinal axis 151a along the axial direction X are separated from each other. The misaligned arrangement of the plurality of first fixing arms 113a and the plurality of second fixing arms 113b can firmly limit the pivot shaft 151 and ensure flexible rotation of the pivot shaft 151. Therefore, even during the process of inserting and removing the electronic component carrier 200 into and from the board-end connector 100 multiple times, the pivot shaft 151 can still maintain stability and smooth rotation effects.

Please refer to FIGS. 1-9 simultaneously. In some embodiments of the present disclosure, the rotating board 150 includes a slot 157, in which the slot 157 is a structure recessed in the rotating board 150. In other embodiments, the slot 157 is a through hole communicating opposite sides of the rotating board 150.

Specifically, the slot 157 of the rotating board 150 is arranged corresponding to the second fixing arm 113b. When the rotating board 150 moves around the pivot shaft 151 along the rotational direction R1, the slot 157 also moves around the pivot shaft 151 along the rotational direction R1, so that the second fixing arm 113b selectively inserts into the slot 157 or leaves the slot 157. Therefore, the second fixing arm 113b can be received in the slot 157. In addition, the slot 157 can effectively prevent the rotating board 150 from directly colliding with or squeezing the second fixing arm 113b, thereby reducing the risk of damaging the second fixing arm 113b. Therefore, the design of the slot 157 not only optimizes the utilization of structural space but also improves the durability and reliability of the components.

Please refer to FIGS. 1-3 simultaneously. In some embodiments of the present disclosure, the board-end connector 100 can further be used in combination with a circuit board 300 (the circuit board 300 can be, for example, a double-sided printed circuit board, a multi-layer circuit board, a rigid circuit board, or a flexible circuit board). Specifically, the rear end portion 137 of the terminal set 130 is substantially L-shaped, and the rear end portion 137 is at least partially disposed outside the housing 110. The rear end portion 137 can provide a larger welding contact area and firmer mechanical support, and it further ensures that the board-end connector 100 can be reliably welded to the circuit board 300. Therefore, the rear end portion 137 forms a solid electrical connection with the circuit lines of the circuit board 300.

FIGS. 1 and 4-6 and 8 are drawn substantially to scale. In order to keep the specification concise, the proportions of each component are not listed one by one, but the proportions and positions of each component should be regarded as a part of the content of this specification.

In summary, the board-end connector of the present disclosure, by the ingenious design of rotating boards and terminal sets, can easily adapt to electronic component carriers of different thicknesses, thereby providing extremely high versatility. This means that manufacturers do not need to separately develop dedicated connectors for each thickness of the electronic component carrier, which greatly reduces design and production costs. At the same time, the automatic adjustment function of the terminal set makes the installation process simpler and faster, which not only reduces the complexity of operation but also shortens the time required for maintenance and improves overall efficiency. The design of the present disclosure allows the connector to show broad application potential in fields with strict requirements for high-speed and stable transmission, such as artificial intelligence servers. The connector of the present disclosure, with its excellent adaptability, reliability, and ease of use, has become an ideal solution compatible with multiple component sizes.

What is claimed is:

1. A board-end connector, comprising:
a housing comprising an inner cavity, wherein the inner cavity comprises two corresponding inner wall surfaces;
two terminal sets comprising signal terminals and grounding terminals, wherein the two terminal sets are accommodated within the housing and are respectively adjacent to the corresponding inner wall surfaces; and
two rotating boards rotatably connected to the housing and respectively adjacent to the corresponding inner wall surfaces, wherein the two terminal sets are respectively in contact with the two rotating boards, wherein the two rotating boards are configured to, upon being actuated, drive the two terminal sets to elastically deform, thereby respectively moving toward the two inner wall surfaces.

2. The board-end connector of claim 1, wherein one of the two terminal sets comprises a bent portion and an end portion, and one of the two rotating boards comprises a pivot shaft and a distal end in contact with the end portion, wherein a distance between the bent portion and the end portion is smaller than a distance between the pivot shaft and the distal end.

3. The board-end connector of claim 1, wherein one of the two rotating boards comprises a pivot shaft and a groove, and a portion of one of the two terminal sets is accommodated in the groove, wherein the groove is configured to move around the pivot shaft to drive the one of the two terminal sets to move.

4. The board-end connector of claim 1, wherein one of the two rotating boards comprises a pivot shaft and a groove, and a portion of one of the two terminal sets is accommodated in the groove, wherein the groove is configured to be pushed by the one of the two terminal sets to move relative to the pivot shaft.

5. The board-end connector of claim 1, wherein the housing comprises at least one first fixing arm and at least one second fixing arm, and one of the two rotating boards further comprises a pivot shaft, wherein the first fixing arm and the second fixing arm are respectively located at corresponding two sides of the pivot shaft and limit the pivot shaft from at least three sides of the pivot shaft.

6. The board-end connector of claim 5, wherein one of the first fixing arm and the second fixing arm has a protrusion extending toward the other of the first fixing arm and the second fixing arm.

7. The board-end connector of claim 5, wherein the at least one first fixing arm comprises a plurality of first fixing arms, and the at least one second fixing arm comprises a plurality of second fixing arms, wherein the plurality of first fixing arms and the plurality of second fixing arms are arranged in a staggered manner with respect to a longitudinal axis of the pivot shaft.

8. The board-end connector of claim 5, wherein the first fixing arm and the second fixing arm present a misaligned configuration in a direction perpendicular to a longitudinal axis of the pivot shaft.

9. The board-end connector of claim 5, wherein the one of the two rotating boards comprises a slot, wherein the slot is arranged corresponding to the second fixing arm and is configured to move around the pivot shaft to selectively receive the second fixing arm.

10. The board-end connector of claim 1, wherein the board-end connector further comprises a base fixed to and connected within the housing, and one of the two terminal sets is fixed on the base and comprises an L-shaped rear end portion, wherein the L-shaped rear end portion is electrically connected to a circuit board.

11. A board-end connector, comprising:
a housing comprising an inner cavity, wherein the inner cavity comprises an inner wall surface;
a terminal set accommodated within the housing and adjacent to the inner wall surface; and
a rotating board rotatably connected to the housing and in contact with the terminal set, wherein the rotating board comprises a pivot shaft and a distal end, wherein the distal end is configured to move around the pivot shaft to be selectively spaced apart from the inner wall surface by a first distance or a second distance smaller than the first distance, wherein the rotating board is configured to rotate and drive the terminal set to elastically deform toward the inner wall surface, such that a spacing between the distal end and the inner wall surface changes from the first distance to the second distance.

12. The board-end connector of claim 11, wherein the terminal set comprises a bent portion and an end portion in contact with the distal end, wherein a distance between the bent portion and the end portion is smaller than a distance between the pivot shaft and the distal end.

13. The board-end connector of claim 11, wherein the rotating board further comprises a groove, and a portion of the terminal set is accommodated in the groove, wherein the groove is configured to move around the pivot shaft to drive the terminal set to move.

14. The board-end connector of claim 11, wherein the rotating board further comprises a groove, and a portion of the terminal set is accommodated in the groove, wherein the groove is configured to be pushed by the terminal set to move relative to the pivot shaft.

15. The board-end connector of claim 11, wherein the housing comprises at least one first fixing arm and at least one second fixing arm, and the first fixing arm and the second fixing arm are respectively located at corresponding two sides of the pivot shaft and limit the pivot shaft from at least three sides of the pivot shaft.

16. The board-end connector of claim 15, wherein one of the first fixing arm and the second fixing arm has a protrusion extending toward the other of the first fixing arm and the second fixing arm.

17. The board-end connector of claim 15, wherein the at least one first fixing arm comprises a plurality of first fixing arms, and the at least one second fixing arm comprises a plurality of second fixing arms, wherein the plurality of first fixing arms and the plurality of second fixing arms are arranged in a staggered manner with respect to a longitudinal axis of the pivot shaft.

18. The board-end connector of claim 15, wherein the first fixing arm and the second fixing arm present a misaligned configuration in a direction perpendicular to a longitudinal axis of the pivot shaft.

19. The board-end connector of claim 15, wherein the rotating board comprises a slot, wherein the slot is arranged corresponding to the second fixing arm and is configured to move around the pivot shaft to selectively receive the second fixing arm.

20. The board-end connector of claim 11, further comprising a base fixed to and connected within the housing, and the terminal set is fixed on the base and comprises an L-shaped rear end portion, wherein the rear end portion is electrically connected to a circuit board.
